(19) United States
(12) Patent Application Publication
(10) Pub. No.: US 2018/0330392 A1
(43) Pub. Date: Nov. 15, 2018

(54) ELECTRONIC COMMERCE SYSTEM USING JACKPOT DISCOUNT RATE

(71) Applicant: TIME E&M, Seoul (KR)

(72) Inventor: Young Hak JEON, Seoul (KR)

(73) Assignee: TIME E&M, Seoul (KR)

(21) Appl. No.: 15/755,520

(22) PCT Filed: Aug. 25, 2016
(86) PCT No.: PCT/KR2016/009419

§ 371 Date: Feb. 26, 2018

(30) Foreign Application Priority Data
Aug. 25, 2015 (KR) 10-2015-0119809

(51) Int. Cl. G06Q 30/02; G06Q 30/08

(52) U.S. Cl. CPC G06Q 30/0212; G06Q 30/0283; G06Q 30/08

(57) ABSTRACT

Disclosed is an electronic commerce system using a jackpot discount rate and providing a price discount service to a customer. To this end, provided is an electronic commerce system using a jackpot discount rate, the electronic commerce system comprising a web server, which analyzes an electronic commerce earnings rate on the basis of purchase information transmitted from a plurality of purchaser terminals, extracts a jackpot discount rate exceeding earnings expected by sales of a bidding product according to an excess earning rate when the earnings rate exceeds a predetermined earnings rate, determines a jackpot price to which the jackpot discount rate is applied, and provides information on the jacket price to the purchaser terminals. According to the present invention, provided is an opportunity to purchase the bidding product at the price for which the jackpot discount rate is applied according to the generation of earnings, such that a customer's sense of expectation is stimulated and the number of shopping mall visits increases

### TECHNICAL FIELD

The present invention relates to an electronic commerce system using a jackpot discount rate to provide a price discount service to customers, and more particularly, to an electronic commerce system using a jackpot discount rate to provide a sale price to which a discount rate is applied according to a profit produced by sales of a bid product.

### BACKGROUND ART

Recently, electronic commerce, which is a transaction of buying or selling online, has become common due to development of the Internet and communication technology. Here, electronic commerce means any transaction involving the buying or selling of goods or services online.

In electronic commerce shopping malls according to the prior art, transactions take place in a manner that a buyer decides to purchase at a predetermined price, that is, static pricing. In the case where transactions take place at static pricing, buyers decide to purchase a bid product by checking the price of the bid product while visiting many electronic commerce sites or comparing the price with a price of the same bid product on a separate price comparison site, and thus the interest of participants may not be aroused.

In order to address this issue, transaction using an auction method, which is a rudimentary step of dynamic pricing, has been proposed, and a transaction allowing buyers and sellers to haggle online has also been proposed.

However, such prior art techniques require a buyer or a seller to re-connect to the website or to suggest and confirm desired conditions discontinuously via e-mail, and accordingly transaction takes a lot of time. Further, many transaction opportunities are lost.

### DISCLOSURE

### Technical Problem

Therefore, it is one object of the present invention to provide an electronic commerce system using a jackpot discount rate that provides an opportunity for consumers to purchase a bid product at a price lower than cost if a certain level of margin is produced when the bid product is sold.

### Technical Solution

In accordance with one aspect of the present invention, provided is an electronic commerce system using a jackpot discount rate, comprising a web server for storing and distributing selling information on a bid product, and a plurality of buyer terminals for accessing the web server over a network including wired and wireless communication networks to be selectively provided with the selling information on the bid product and to provide purchase information to the web server, wherein the web server stores the purchase information transmitted from the plurality of buyer terminals, extracts a jackpot discount rate by analyzing accumulated purchase information, determines a jackpot price by applying the jackpot discount rate, and provides information on the jackpot price to the buyer terminals.

In accordance with another aspect of the present invention, provided is an electronic commerce system using a jackpot discount rate, comprising a web server for storing and distributing selling information on a bid product, and a plurality of buyer terminals for accessing the web server over a network including wired and wireless communication networks to be selectively provided with the selling information on the bid product and to provide purchase information to the web server, wherein the web server determines a variable discount rate upon receiving a request signal from a buyer terminal, determines a sale price of the bid product by applying the variable discount rate, provides the buyer terminal having transmitted the request signal with information on the sale price, and analyzes an electronic commerce profit rate based on the purchase information, wherein, when the profit rate exceeds a predetermined profit rate, the web server extracts a profit expected by selling of the bid product according to the excess profit rate and a jackpot discount rate exceeding the variable discount rate, determines a jackpot price by applying the jackpot discount rate, and provides information on the jackpot price to the buyer terminals.

### Advantageous Effects

According to the present invention, an opportunity to purchase a bid product at a price to which not only a variable discount rate but also a jackpot discount rate is applied may be provided, thereby stimulating customers and increasing the number of visits to a shopping mall.

The present invention may enhance customer satisfaction and loyalty by returning a part of a produced profit to consumers if the profit is higher than or equal to a predetermined level.

In addition, according to the present invention, a buyer is allowed to invest in either time or virtual money to have an opportunity to purchase a bid product at a discounted price lower than a basic sale price, and a system manager can encourage buyers to use the virtual money or to watch an advertisement, and thus obtain additional income through sales of virtual money and advertising costs in addition to broker fees for selling of bid products.

In addition, the present invention may increase the sales volume of a bid product by arousing interest of buyers by providing a service of irregularly discounting the purchase price of the bid product according to investment of time or points.

Further, the present invention provides the buyer with an opportunity to purchase the bid product at a low price because the cost of discounting the bid product may be higher than the cost of using points for the buyer.

### DESCRIPTION OF DRAWINGS

FIG. 1 is a diagram of online connection of an electronic commerce system according to an embodiment of the present invention.

FIG. 2 is a block diagram showing configuration of a web server according to an embodiment of the present invention.

FIG. 3 is a graph depicting a variable discount rate according to a first embodiment of the present invention.

FIG. 4 is a graph depicting a variable discount rate according to a second embodiment of the present invention.

FIG. 5 is a graph depicting a variable discount rate according to a third embodiment of the present invention.

FIG. 6 is a graph depicting a variable discount rate according to a fourth embodiment of the present invention.

FIG. 7 is a graph depicting sale prices of a sold bid product.

FIG. 8 is an operational flowchart illustrating an embodiment of an electronic commerce method according to the present invention.

### BEST MODE

Hereinafter, an electronic commerce system using a jackpot discount rate (hereinafter simply referred to as “electronic commerce system”) according to preferred embodiments of the present invention will be described in detail with reference to the accompanying drawings.

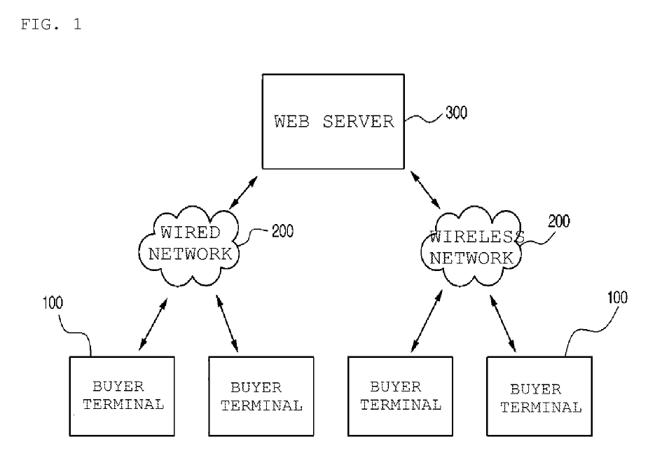

FIG. 1 is a diagram of online connection of an electronic commerce system according to an embodiment of the present invention.

Referring to FIG. 1, an electronic commerce system according to the present invention includes a web server 300 and a plurality of buyer terminals 100 connected to the web server 300 over a network including wired/wireless communication networks (hereinafter referred to as “network”).

Here, the sales information is uploaded and stored on the web server 300 through a seller terminal or the interface of the web server 300 and is retrieved and extracted by the web server 300 at the request of the buyer terminal 100. Then, the extracted sales information is transmitted to the buyer terminal 100 by the web server 300.

Hereinafter, respective components will be described in more detail with reference to the drawings.

Referring to FIG. 1, the electronic commerce system according to the present invention includes buyer terminals 100.

The buyer terminals 100 access the web server 300 over the network 200 to receive sales information on a bid product, transmit a sale price check request signal, in order to check a “time sale price” (hereinafter referred to as “sale price”), which is determined by applying a variable discount rate according to time or the like, and transmit purchase price information on the bid product. Here, a sale price check request signal may include a request signal input through one of virtual money settlement, free participation, and advertisement viewing.

More specifically, the buyer terminal 100 may be configured to receive the transmitted sales information on the bid product and display the sales information. The sales information on the bid product may include items (purchase, reservation, display of maximum discount rate, etc.) for selecting a bid on the bid product and bid-related information such as a bid product name, a picture of a bid product, a feature of a bid product, a seller name, a deadline, and a remaining stock.

In addition, the buyer terminal 100 receives a web page from the web server 300 connected over the network 200, and outputs the web page on the screen. Then, the buyer terminal 100 receives a touch of a virtual money settlement menu item, a free participation menu item, or an advertisement viewing menu item from a user to check the sale price to which a variable discount rate is applied through the web page, and transmits a sale price check request signal through the menu.

For example, in the case where the buyer terminal 100 transmits a sale price check request signal to the web server 300 through virtual money settlement, the buyer terminal 100 receives information on the sale price within a few seconds (about one second) from the web server 300 and outputs the same on the screen.

In the case where the buyer terminal 100 transmits a sale price check request signal to the web server 300 through advertisement viewing, the buyer terminal 100 receives an about 15 to 20 second long advertisement from the web server 300 and outputs the same. Thereafter, the buyer terminal receives information on the sale price from the web server 300 and outputs the same through the screen.

In addition, in the case where the buyer terminal 100 transmits a sale price check request signal to the web server 300 through free participation, the buyer terminal receives countdown information of twice the advertisement output time, for example, 30 seconds, from the web server 300 and offers the same. Thereafter, the buyer terminal receives information about the sale price from the web server 300 and outputs the information through the screen.

Additionally, the buyer terminal 100 receives information on a jackpot price from the web server 300 and outputs the information on the screen.

As described above, the buyer terminal 100 refers to a means capable of accessing, over a wireless communication network or a wired communication network, the web server 300 that provides an electronic commerce service. Here, as the wireless buyer terminal 100, a smartphone, a computer, various communication terminals, a television, a corded telephone, or the like may be used.

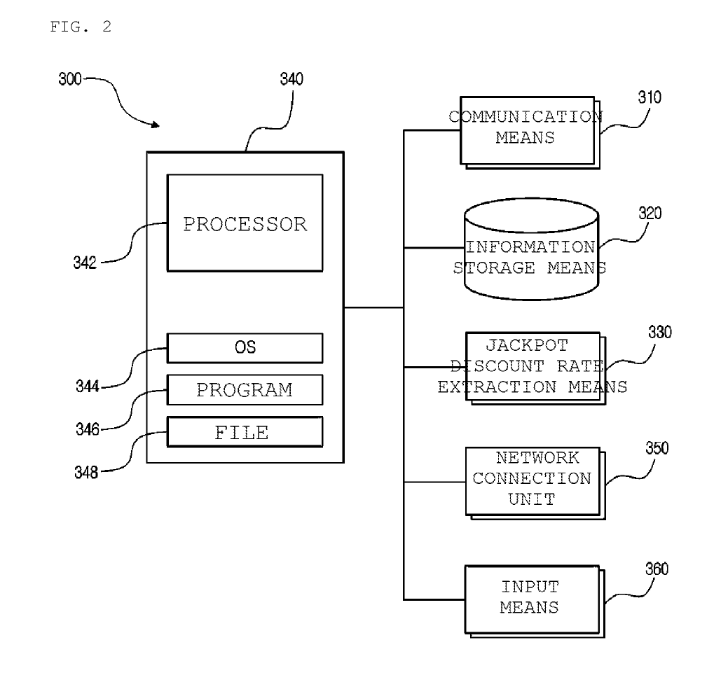

FIG. 2 is a block diagram showing configuration of a web server according to an embodiment of the present invention. Referring to FIGS. 1 and 2, the electronic commerce system according to the present invention includes a web server 300.

The web server 300 is configured to sell a bid product at a jackpot price a limited number of times or for a limited time so as to return a portion of a profit to a buyer who purchases the bid product through a web page provided by the web server.

To this end, the web server 300 stores purchase information transmitted from a plurality of buyer terminals 100, extracts a jackpot discount rate by analyzing the accumulated (cumulative) purchase information, determines a jackpot price to which the jackpot discount rate is applied, and provides the buyer terminal 100 with information on the jackpot price.

In a first embodiment, the web server 300 according to the present invention analyzes an electronic commerce profit rate based on the purchase information, extracts the jackpot discount rate in each range of the excess profit rate when the profit rate exceeds the designated profit rate, and determines the jackpot price with the jackpot discount rate applied thereto. Then, the web server provides the buyer terminal 100 with information on the jackpot price. Here, the jackpot discount rate is preferably set in a range exceeding the profit expected by the web server operator when the bid product is sold.

In a second embodiment, the web server 300 according to the present invention analyzes cumulative quantity of sales based on the purchase information and extracts the number of times of application of a jackpot discount rate and jackpot discount rate specified for each range of the quantity of sales, and determines the jackpot price with the jackpot discount rate applied thereto. Then, the web server provides the buyer terminal 100 with the information on the jackpot price. For example, the web server 300 randomly selects any one sale between the one-hundredth sale and the two-hundredth sale of the bid product and provides the buyer terminal 100 with the selling price of the bid product to which the jackpot price is applied. Specifically, the number of times of application of the jackpot discount rate is applied may be set to 1 for sales between the one-hundred-first sale and the two-hundredth sale of the bid product, 2 sales between the two-hundred-first sale and the three-hundredth sale, and 3 for sales between the three-hundred-first sale and the four-hundredth sale.

In a third embodiment, the web server 300 according to the present invention analyzes the cumulative number of sales based on the purchase information, extracts a jackpot discount rate specified for the number of sales, such as one-hundredth and two-hundredth, and determines the jackpot price with the jackpot discount rate applied. Next, information on the jackpot price is provided to the buyer terminal 100.

More specifically, as shown in FIG. 2, the web server 300 includes a communication unit 310 for communication with the outside, an information storage means 320 in which sales information and purchase information on a bid product are classified and stored, a jackpot discount rate extraction means 330 for extracting a jackpot discount rate limitedly according to the profit rate of electronic commerce and the cumulative quantity of sales of the bid product, a host unit 340 for controlling the overall operation of the system and determining a jackpot price of the bid product to which the jackpot discount rate is applied, and a network connector 350 for connecting to a network 200 such as the Internet. If necessary, the web server 300 may further include an input means 360 for a user interface.

The communication means 310 according to the present invention transmits sales information on the bid product such as the quantity of sales and the cost of the bid product to the buyer terminal 100 over the network 200 and receives purchase information on the bid product transmitted from the buyer terminal 100. The communication means 310 is connected to the seller terminal over the network 200 to collect sales information on the bid product including the cost, the total quantity of sales, and the maximum discount rate from the seller terminal (not shown).

The information storage means 320 stores the collected selling information and purchase information on the bid products, the expected profit information on each bid product, and the jackpot discount rate information for each excess profit range. The information storage means 320 includes multiple databases (DB), and preferably includes a selling information DB, a purchase information DB, an expected sales profit per bid product DB, and a jackpot discount rate per excess profit DB.

The selling information DB is a database containing specific information on sellers and bid products. The DB includes an original price (initial price) of a bid product, a total quantity of sales, a maximum discount rate, a bid product name, a feature of the bid product, seller ID and password, the date and time of storing the selling information, and the personal information on the seller. The information on each bid product stored in the selling information DB can be partially inquired at any time through the buyer terminal 100 registered as a service member.

The purchase information DB is a DB containing specific information on a buyer and a bid product purchased by the buyer. The DB may include information such as the name of a purchased bid product, a date of the transaction of the bid product, a sale price of the bid product, a variable discount rate applied to the sale price, the amount of sales paid to the seller, the ID and password of the buyer, the personal information on the buyer, and the remaining quantity of sales.

The expected sales profit per bid product DB stores the profit amount per bid product that the operator of the web server 300 can obtain when the sale is completed.

The jackpot discount rate per excess profit DB stores a jackpot discount rate specified for each range of the excess profit with respect to the reference profit when the profits exceeding the reference profit set by the operator of the web server 300 are generated. For example, if an excess profit rate higher than or equal to 1% and lower than 10% is achieved, the jackpot discount rate may be set 60%. The jackpot discount rate may be set to 70% if an excess profit rate higher than or equal to 10% and less than 50% is achieved. The jackpot discount rate is set to 80% if an excess profit rate higher than or equal to 50% and less than 100% is achieved. If necessary, the jackpot discount rate may be set to a maximum discount rate of 100%. In this case, the selling price of the bid product is 0 WON.

The jackpot discount rate extracting means 330 according to the present invention analyzes the electronic commerce profit rate through the purchase information stored in the information storage means 320 and the expected profit DB in real time, and extracts a jackpot discount rate from the jackpot discount rate DB according to the profit rate. The jackpot discount rate extracting means 330 analyzes the cumulative quantity of sales of the bid products through the purchase information stored in the information storage means 320 in real time and extracts a jackpot discount rate according to each range of sales quantity or the number of sales specified for the sales quantity.

At this time, extraction of the jackpot discount rate is performed a limited number of times or for a limited time duration. This is intended to prevent the jackpot price obtained by applying a jackpot discount rate from being exposed to the buyer terminal for a long time and rapidly deteriorating the cumulative profit rate of the operator of the web server.

More specifically, the jackpot discount rate extracting means 330 stops extracting the jackpot discount rate if the electronic commerce profit rate does not exceed a predetermined reference profit rate. In addition, the jackpot discount rate extracting means 330 extracts a jackpot discount rate set for each range of excess profit rate from the jackpot discount rate per excess profit DB when the electronic commerce profit rate exceeds the predetermined reference profit rate.

The input means 360 according to the present invention is provided to allow the administrator of the web server 300 to directly upload the selling information on the bid products to the web server 300 without using the communication means 310, and may be connected to the information storage means 320 to store the selling information therein. Here, any input means 360 may be used.

The host unit 340 according to the present invention applies the jackpot discount rate extracted from the jackpot discount rate extracting unit 330 to the selling price (initial price) of the bid product for which the sale price check request signal is received from the buyer terminal 100. The jackpot price is transmitted to the buyer terminal 100 having provided the sale price check request signal. To this end, the host unit 340 includes a processor 342 connected to the communication means 310, the information storage means 320 and the jackpot discount rate extracting means 330 to control the means and a program 346 for controlling the processor 342.

More specifically, the host unit 340 may be provided with a processor 342, an operating system 344, a file 348, and a program 346 for controlling the file 348.

The processor 342 analyzes the selling information stored in the information storage means 320 according to the program 346 to determine a sale price (sale selling price) of the bid product to which an irregular variable discount rate is applied in each time range within the range of the maximum discount rate, and transmits the sale price to the buyer terminal 100 through the communication means 310. In addition, when a jackpot discount rate is extracted upon receiving of a sale price check request signal, the processor 342 determines the jackpot price (jackpot selling price) of the bid product to which the jackpot discount rate is applied, and transmits the jackpot price to the buyer terminal 100 through the communication means 310. Once the jackpot price is determined, the processor 342 transmits the jackpot price to the buyer terminal 100 together with the sale price or transmits the jackpot price to the buyer terminal 100 in place of the sale price. At this time, the processor 342 may be configured to output the sale price and the jackpot price only for the time set for the buyer terminal according to the program 346.

If necessary, the processor 342 may calculate the remaining quantity of sales by analyzing the purchase information stored in the information storage means 320, and transmit the remaining quantity of sales to the buyer terminal 100 through the communication means 310. The processor may restrict the additional purchase by the buyer terminal 100 when the total quantity for sales is sold out.

When receiving a member registration request from the buyer terminal 100, the host unit 340 may receive, from the buyer terminal 100, member information, for example, name, resident registration number, sex, age, address, email address, wireless terminal number, ID, password, and the like, authenticate the same, assign an ID and a password, and then store the related member information in the information storage means 320.

When a request for transmission of the selling information on the bid product is received from the buyer terminal 100, the host unit 340 searches the information storage means 320 in which the selling information on the bid product is stored, extracts the corresponding selling information, and transmits the selling information to the buyer terminal 100 through the communication means 310.

Optionally, the host unit 340 may operate to analyze the purchase information at the request of the buyer terminal 100 and transmit information on the maximum discount rate to a buyer terminal 100 having paid a separate agreed money and a buyer terminal 100 having a predetermined number of purchases, for example, more than 5 to 100 purchases. In addition, the host unit 340 may analyze the buyer information at the request from the buyer terminal 100 and may operate to transmit the information on the maximum discount rate to a buyer terminal 100 having mileage of a predetermined amount or more.

When a request for reservation of a bid product which has been sold is received from the buyer terminal 100 through the communication means 310, the host unit 340 stores the purchase information in the information storage means 320. Thereafter, when the selling information on the corresponding bid product is updated at the seller terminal 100, the host unit 340 may operate to transmit the selling information on the bid product to the buyer who requested the reservation through SMS or email, using the purchase information stored in the information storage means 320.

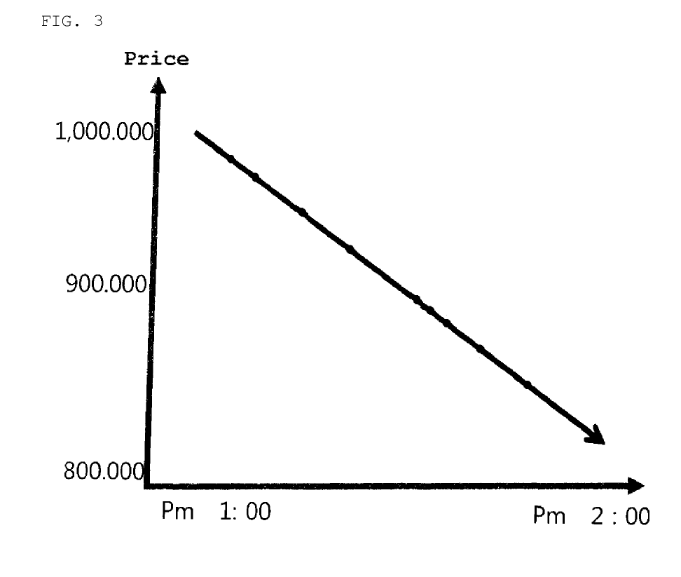

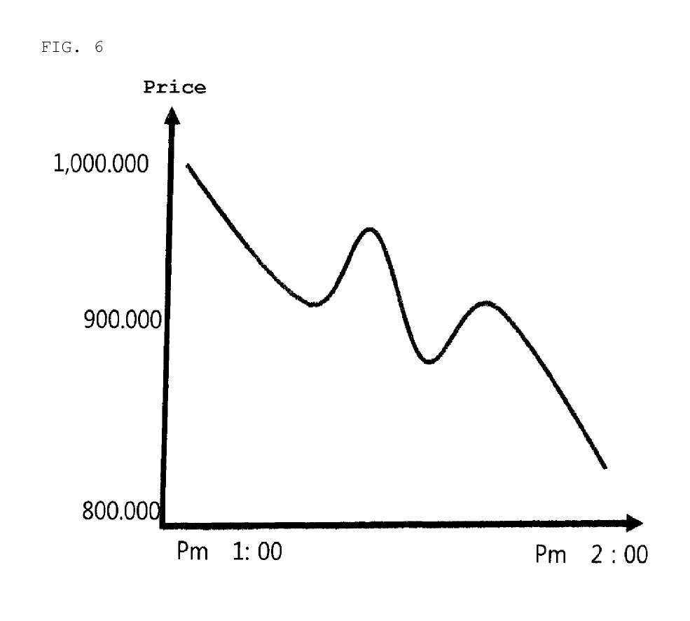

FIGS. 3 to 6 are graphs depicting an irregular variable discount rate according to an embodiment of the present invention.

One of a direct discount rate, a random discount rate, a direct random discount rate may be used as the irregular variable discount rate, or one of the direct discount rate, the random discount rate, and the direct random discount rate may be randomly selected and used as the irregular variable discount rate.

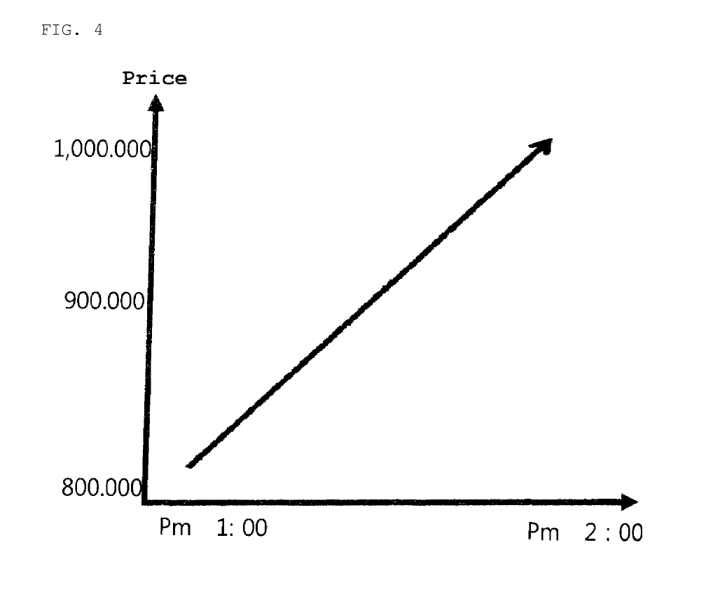

More specifically, the direct discount rate is a discount rate that exhibits a regular rise or fall in time units as shown in FIGS. 3 and 4.

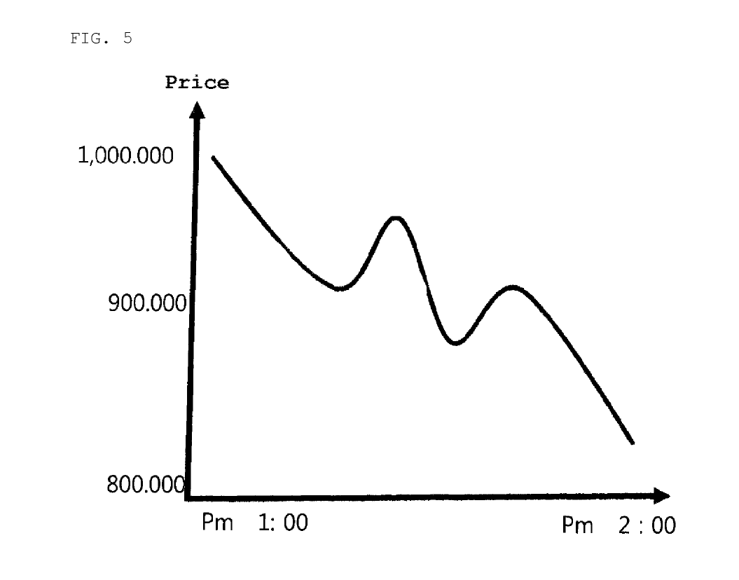

As shown in FIG. 5, the random discount rate is a discount rate that repeats irregular rise and fall in time units.

For example, a random down discount rate and a random up discount rate may be applied as the random discount rate. More specifically, the random down discount rate is a discount rate that falls as a whole, but increases or decreases in time units. And the random up discount rate rises as a whole, but increases or decreases in time units.

The direct random discount rate is a discount rate that repeats irregular rise or fall while increasing or decreasing regularly in time units.

If necessary, as shown in FIG. 3, the host unit 340 may construct a graph of an irregular variable discount rate which is exposed to the buyer terminal and a jackpot discount rate graph which exposes an ID of a buyer who has purchased the bid product at a price formed by applying an irregular variable discount rate and a jackpot discount rate. This confirms actual applications of the variable discount rate and the jackpot discount rate by showing a buyer the buyers who have purchased the bid product at the price formed by applying the variable discount rate and the jackpot discount rate, encouraging the buyer to actively purchase the bid product.

Meanwhile, the direct discount rate, the random discount rate, and the direct random discount rate may be restarted from the initial discount rates when a predetermined time passes.

As described above, since the direct discount rate, the random discount rate, or the direct random discount rate is selected as the irregular variable discount rate by the administrator of the web server or randomly selected by the host unit 340 to determine the selling price for each time unit, the buyer cannot predict the selling price of the bid product.

However, the seller may select one of the direct discount rate, the random discount rate, and the direct random discount rate through the seller terminal and request the web server 300 to use the selected discount rate as the variable discount rate of the bid product.

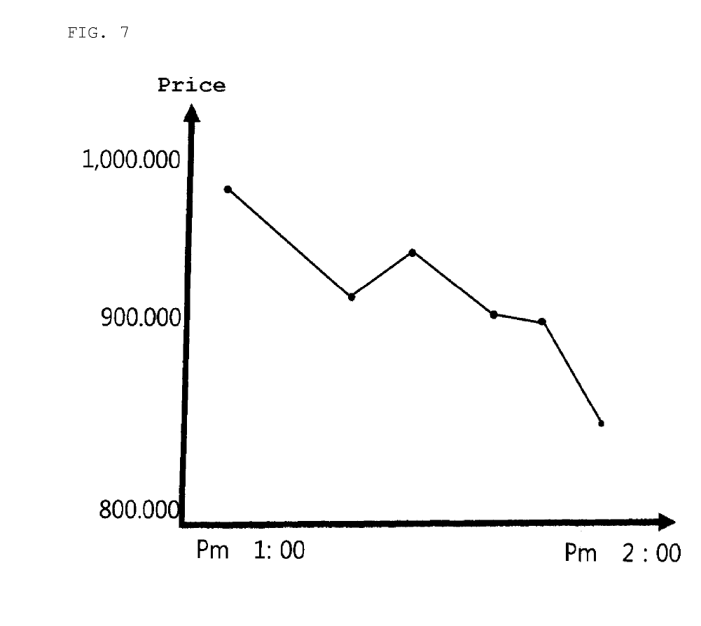

If necessary, the host unit 340 may provide a function of outputting a graph of sale prices of a sold bid product as shown in FIG. 7 according to a request from a the buyer terminal.

More specifically, the host unit 340 may construct a graph of sale prices of a sold bid product such that the buyer can easily check the actual sale price of the sold bid product through the buyer terminal. This allows the buyer to intuitively recognize the change in the sale price of the sold bid product by excluding the graph of the variable discount rate, thereby actively encourage the buyer to actively purchase the bid product.

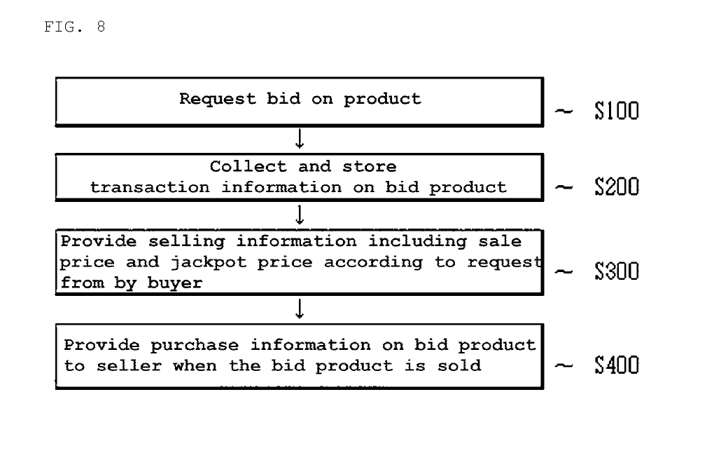

FIG. 8 is an operational flowchart illustrating an embodiment of an electronic commerce method according to the present invention. The electronic commerce method according to FIG. 8 is executed through the electronic commerce system described above.

As shown in FIG. 8, the electronic commerce method according to the present invention may include a step S100 of accessing, by a seller terminal, the web server 300 over the network 200 to provide selling information and requesting a bid on a bid product, a step S200 of registering, by the web server 300, a user of the buyer terminal 100 as a seller and storing selling information of the bid product in response to the bid request, a step S300 of, when the buyer terminal 100 accesses the web server 300 and make a request for check of the sale price of the bid product, calculating, by the web server 300, a sale price (sale selling price) to which an irregular variable discount rate is applied for each time period, calculating a jackpot price (jackpot selling price) obtained by applying the jackpot discount rate to each profit rate of electronic commerce a limited number of times or for a limited time duration, and transmitting the sale price and the jackpot price to the buyer terminal 100, a step S400 of, when the buyer terminal 100 checks a changed selling price of the bid product and purchases the bid product, storing, by the web server 300, the purchase information of the buyer terminal 100 and transmitting the purchase information to the seller terminal 100 that has uploaded the selling information on the bid product.

More specifically, the routine of FIG. 8 is performed by the web server 300 to start the operation of the electronic commerce system. Once the operation started, the host unit 340 of the web server 300 controls the overall operation and stores various data in the information storage means 320 or reads various data from the information storage means 320, receives a user command or data through the input unit 360, and communicates with an external device through the communication means 310 and the network connection unit 350.

In the electronic commerce method according to the present invention, the buyer terminal 100 connects to the communication means 310 of the web server 300 over the network 200 first to provide selling information, and then requests a bid on the bid product (S100).

When the seller terminal make a request for a bid to the web server 300 as described above, the web server 300 responds to the bid request, and the processor 342 of the host unit 340, which is connected to the communication means 310, registers the user of the seller terminal as a seller, and stores selling information on the bid product in the information storage means 320 (S200).

Subsequently, when the buyer terminal 100 accesses the web server 300 and requests a sale price search for the bid product, the processor 342 of the host unit 340 analyses the selling information stored in the information storage means 320 according to the program 346 to calculate the sale price of the bid product to which the irregular variable discount rate is applied within the range of the maximum discount rate, and provides the sale price to the buyer terminal 100 until the bid on the bid product is closed (S300).

In step S300, when the profit rate exceeding the designated profit rate is obtained by analyzing the purchase information and the expected profit information, the jackpot discount rate is extracted a limited number of times or for a limited time duration, and the jackpot price of the bid product obtained by applying the jackpot discount rate is calculated, and the jackpot price is provided to the buyer terminal 100. At this time, the web server may extract a jackpot discount rate specified for each quantity of sales by analyzing the accumulated quantity of sales of the bid product instead of the excess profit rate, or extract a jackpot discount rate specified for each number of times of sales by analyzing the accumulated number of times of sales.

In addition, in step S300, the purchase information stored in the information storage means 320 is analyzed to calculate the remaining quantity of sales, and the calculated quantity is transmitted to the buyer terminal 100

Finally, when the buyer confirms the sale price of the bid product and purchases the bid product through the buyer terminal 100, the host unit 340 stores the purchase information of the buyer terminal 100 in the information storage means 320 and transmits the purchase information to the seller terminal of the seller who has uploaded the selling information on the corresponding bid product (S400).

A process in which the web server 300 provides selling information on a bid product when the buyer terminal 100 requests a search for the bid product over the network 200 is performed as follows.

The process includes a step S310 of the buyer terminal 100 requesting the web server 300 to search for a bid product over the network 200, a step S320 of calculating a remaining quantity of sales of the bid product through the web server 300 when the remaining quantity of sales is greater than or equal to 1, a step S325 of restricting purchase of the bid product and generating, through the web server 300, says information indicating that selling of the bit product will be stopped when the remaining quantity of sales is 0, a step S330 of calculating, through the web server 300, a sale price obtained by applying the irregular variable discount rate in a time period when the buyer terminal 100 requests search for the bid product and calculating a jackpot selling price obtained by applying the jackpot discount rate at the time when the buyer terminal 100 requests the search for the bid product, a step S340 of storing the sale price and the jackpot price in the web server 300 in relation to provision of selling information, a step S350 of transmitting the selling information including the sale price and the jackpot price to the buyer terminal 100 over the network 200.

More specifically, in step S310, when the buyer terminal 100 requests the web server 300 to search for a bid product, the communication means 310 of the web server 300 receives the request and forwards the request to the host unit 340.

In step S320, the host unit 340 of the web server 300 calculates the remaining quantity of sales of the corresponding bid product. The host unit 340 searches the information storage means 320 for the bid product requested by the buyer terminal 100, extracts the contents about the bid product, and then calculates the remaining quantity of sales of the bid product.

In step S325, if the remaining quantity of sales of the bid product retrieved by the host unit 340 is 0, the host unit 340 restricts purchase of the bid product and generates selling information indicating that selling the bid product is stopped.

In step S330, the host unit 340 calculates a sale price by applying an irregular variable discount rate in a time period for requesting a search for a selling price of the bid product such that the selling price of the bid product can be determined, and calculates the jackpot price by applying the jackpot discount rate at the time of request for search of the selling price of the bid product. At this time, when the jackpot discount rate is extracted, the jackpot price is used alone for the selling information, or the sale price and the jackpot price are used together for the selling information. If the jackpot discount rate is not extracted, the sale price is used alone for the selling information.

In step S340, the calculated sale price and jackpot price are stored in the information storage means 320 of the web server 300.

In step S350, information for restricting purchase of the bid product or the selling information including the selling price (sale price and jackpot price) of the bid product is transmitted to the buyer terminal 100 of the buyer.

In general, the prices of all products are fixed in the seller-centered electronic commerce system. However, for a product or service with a short distribution period, the price is likely to decrease as the end of the distribution period comes near. For example, in the case of products or services such as available rooms in a hotel, tickets for performances such as plays or movies, flight tickets, tickets for expressway buses or trains, or flowers and agricultural and marine products that have already been shipped to the market and whose values are lowered as time passes, selling the products even at a lower price before the expiration date may maximize the sellers' profit.

The fact that the same product or service can be purchased at a lower price as the time passes increases the desire to purchase and transactions through flexible price formation can make a profit for both the seller and the buyer. However, for the products or services having an early expiration date, cutting the prices at a constant rate is not the way to maximize the seller's benefits.

In the case of a commercial product having a relatively long distribution period unlike a product or service having a short distribution period, if an electronic commerce method allowing the same product to be purchased at a lower price as time elapses within a predetermined time period is used, buyers are likely to purchase the bid product at the lowest price by delaying the time to purchase the product as long as possible. This may not only reduce the profit to the seller of bid products but also increase the distribution cost of the product due to delayed sales of the product.

However, the electronic commerce system and method according to the present invention allows selling of a limited number of items, for example, about 1 to 100 items, and operates such that the buyer cannot predict the discount rate of the bid product in a specific time period, thereby preventing delayed purchase at a lower price of the bid product and reducing the distribution cost of the bid product. In addition, the electronic commerce system and method causes buyers to buy a bid product on a first-come-first-served basis through a competition, thereby inducing interest to the buyers and maximizing a sales profit of a bid product by selling the bid product even in a time period in which a maximum discount rate is not applied. In addition, since a paid member who deposits a separate amount of money to receive information on the maximum discount rate that is not announced can be secured, a separate profit can be obtained in addition to the commission for selling the bid product. In addition, since it is possible to secure buyers who persistently performs purchases to receive information about the maximum discount rate that is not announced, the commission for selling the bid product can be steadily secured. Furthermore, the loyalty of buyers and the usage rate of electronic commerce may be increased by returning a portion of the profits from the sale of the bid product to the buyer (selling the product at a jackpot discount rate that is higher than the maximum discount rate of the variable discount rate).

It will be apparent to those skilled in the art that various modifications and variations can be made in the present invention without departing from the spirit and scope of the invention as defined in the appended claims.

It will be apparent to those skilled in the art that various modifications and variations can be made in the present invention without departing from the spirit and scope of the invention as defined in the appended claims.

1. An electronic commerce system using a jackpot discount rate, comprising a web server for storing and distributing selling information on a bid product, and a plurality of buyer terminals for accessing the web server over a network including wired and wireless communication networks to be selectively provided with the selling information on the bid product and to provide purchase information to the web server,
wherein the web server stores the purchase information transmitted from the plurality of buyer terminals, extracts a jackpot discount rate by analyzing accumulated purchase information, determines a jackpot price by applying the jackpot discount rate, and provides information on the jackpot price to the buyer terminals.

2. The electronic commerce system according to claim 1, wherein the web server analyzes an electronic commerce profit rate based on the purchase information,
wherein, when the profit rate exceeds a predetermined profit rate, the web server extracts a jackpot discount rate exceeding a profit expected by selling of the bid product according to an excess profit rate, determines a jackpot price by applying the jackpot discount rate, and provides the information on the jackpot price to the buyer terminals.

3. The electronic commerce system according to claim 1, wherein the web server analyzes a cumulative quantity of sales based on the purchase information, extracts a jackpot discount rate designated for each range of the quantity of sales, determines a jackpot price by applying the jackpot discount rate, and provides the information on the jackpot price to the buyer terminal.

4. The electronic commerce system according to claim 1, wherein the web server analyzes a cumulative number of times of sales based on the purchase information, extracts a jackpot discount rate designated to the number of times of sales, determines a jackpot price by applying the jackpot discount rate, and provides the information on the jackpot price to the buyer terminals.

5. The electronic commerce system according to claim 1, wherein the web server comprises:
a communication means for transmitting the selling information on the bid product to the buyer terminals over the network and receiving the purchase information on the bid product from the buyer terminals;
an information storage means for storing the selling information and purchase information on the bid product, an expected profit DB based on sales per bid product, and a jackpot discount rate DB for each excess profit;
a jackpot discount rate extracting means for analyzing an electronic commerce profit rate through the purchase information and the expected profit DB, and extracting a jackpot discount rate from the jackpot discount rate DB according to the profit rate; and
a host unit comprising a program for controlling a processor, and the processor connected to the communication means, the information storage means and a jackpot discount rate determination means to control the means and determine a jackpot price of the bid product by applying the jackpot discount rate extracted from the jackpot discount rate extracting means.

6. An electronic commerce system using a jackpot discount rate, comprising a web server for storing and distributing selling information on a bid product, and a plurality of buyer terminals for accessing the web server over a network including wired and wireless communication networks to be selectively provided with the selling information on the bid product and to provide purchase information to the web server,
wherein the web server determines a variable discount rate upon receiving a request signal from a buyer terminal, determines a sale price of the bid product by applying the variable discount rate, provides the buyer terminal having transmitted the request signal with information on the sale price, and analyzes an electronic commerce profit rate based on the purchase information,
wherein, when the profit rate exceeds a predetermined profit rate, the web server extracts a profit expected by selling of the bid product according to the excess profit rate and a jackpot discount rate exceeding the variable discount rate, determines a jackpot price by applying the jackpot discount rate, and provides information on the jackpot price to the buyer terminals.

7. The electronic commerce system according to claim 6, wherein the request signal is a request signal for one of virtual money settlement, free participation and advertisement viewing.

8. The electronic commerce system according to claim 7, wherein, when the advertisement viewing request signal is received, the web server exposes a pop-up advertisement to the corresponding buyer terminal for a designated time, and then transmits the information on the sale price to the corresponding buyer terminal,
wherein, when the free participation request signal is received, the web server counts a time longer than the time for the pop-up advertisement, and then transmits the information on the sale price to the corresponding buyer terminal.

9. The electronic commerce system according to claim 6, wherein the electronic commerce profit rate is divided into one of a single bid product, a single bid product type, and a single category and analyzed.

10. The electronic commerce system according to claim 6, wherein the web server comprises:
a communication means for transmitting the selling information on the bid product to the buyer terminals over the network and receiving the purchase information on the bid product from the buyer terminals;
an information storage means for storing the selling information and purchase information on the bid product, an expected profit DB based on sales per bid product, and a jackpot discount rate DB for each excess profit;
a jackpot price determination means for analyzing an electronic commerce profit rate through the purchase information and the expected profit DB, and extracting a jackpot discount rate from the jackpot discount rate DB according to the profit rate, and determining a jackpot price by applying the jackpot discount rate; and
a host unit comprising a program for controlling a processor, and the processor connected to the communication means, the information storage means and the jackpot price determination means to control the means and to determine a sale price of the bid product by applying an irregular variable discount rate for each time period within the range of a maximum discount rate by analyzing the selling information.

11. The electronic commerce system according to claim 6, wherein the variable discount rate is a discount rate randomly selected from among a direct discount rate exhibiting a regular rise or fall in time units, a random discount rate repeating irregular rise and fall in time units, or a direct random discount rate repeating irregular rise and fall while increasing or decreasing regularly in time units.
